(19) United States
(12) Patent Application Publication
(10) Pub. No.: US 2009/0145883 A1
(43) Pub. Date: Jun. 11, 2009

(54) Method for Producing Contact Makers for Vacuum Switching Chambers

(75) Inventor: Dietmar Gentsch, Bochum (DE)

Correspondence Address: BUCHANAN, INGERSOLL & ROONEY PC, POST OFFICE BOX 1404, ALEXANDRIA, VA, 22313-1404, US

(73) Assignee: ABB TECHNOLOGY AG, Zurich (CH)

(21) Appl. No.: 11/918,045

(22) PCT Filed: Apr. 16, 2005
(86) PCT No.: PCT/EP2005/004063

§ 371 Date: Oct. 29, 2008

(51) Int. Cl. H01H 33/66; H01H 11/04; H01H 1/02

(52) U.S. Cl. 218/140; 29/622; 29/746

(57) ABSTRACT

The invention relates to a method for producing contact makers for vacuum switching chambers, which are used in low-voltage, medium-high voltage, and high-voltage engineering, during which the contact makers are provided with slots extending from the middle area of the contact to the edge. The invention also relates to the contact maker itself. In order to improve a method for producing contact makers in vacuum switching chambers as well as a contact maker of the type in question so that the production method is distinctly less complicated, and the contact maker is sufficient for the highest functional demands, the invention provides that the contact makers are produced in a powder metallurgical process in which they are provided with near final contours and near final dimensions. During this process, said slots are already made in the green compact and are fixed during a subsequent sintering.

The invention relates to a method for producing contact makers for vacuum switching chambers of low-voltage, medium-voltage and high-voltage switching chambers, in which the contact makers are provided with slots extending from the middle area of the contact to the edge, and also to a contact maker itself, according to the precharacterizing clause of patent claims 1 and 12.

The technical field relates to low-voltage, medium-voltage, high-voltage and generator switchgear equipped with vacuum switching chambers. Vacuum switching chambers are predominantly equipped with a radial magnetic field (RMF) contact system. The radial magnetic field is generated by means of sickle-shaped coil segments. The sickle-shaped elements are produced by slots that are provided in the contact maker plate.

It is also possible to use a slotted contact pot, which generates the radial magnetic field on an annular surface. However, slots could likewise be required and provided in a contact maker plate. Furthermore, slots are generally also required in a contact plate when AMF contact systems are used.

A major advantage of RMF contact systems is the low current-path resistance of the overall arrangement using a contact pressure force (simple system).

RMF contact makers in the shape of cylindrical disks with rounded outer edges to improve the dielectric properties are generally used.

Metal-cutting methods are used to apply the outer contour and to provide the slots. The outer geometry is accordingly applied by means of a turning operation and the slots are provided in the contact maker by sawing or milling.

In the case of contact plates that are comparatively thin, it is also possible to use stamping methods.

Uses of multilayer contact blanks and contact makers comprising a number of layers are known in the patent literature, according to DE 3840192 A1. This discloses a switching contact arrangement for electrical vacuum switching chambers of which the slotted contact makers are made up of a number of disks placed one on top of the other; the individual disks were previously slotted by stamping. In this case, to obtain satisfactory stamping, the material thickness of the disks is to be chosen such that it is not greater than the width of their slots.

U.S. Pat. No. 6,010,659 and EP 1111631 respectively disclose a method for producing a multilayer contact that comprises a number of layers. They also describe the possibility of producing a contact from the two layers CuCr and copper, for example in a ceramic crucible by the sintering and melting method.

The known method for providing the slots is a metal-cutting method, the slots being generated for each contact maker at a time. This also applies to the application of an outer contact geometry. Generating the contact maker geometry by metal-cutting techniques of course involves corresponding costs.

The invention is therefore based on the object of improving a method for producing contact makers in vacuum switching chambers and also a contact maker of the generic type to the extent that the production method itself is made much simpler, and the contact maker meets the highest functional requirements.

The set object is achieved according to the invention in the case of a method of the generic type by the characterizing features of patent claim 1.

Further advantageous refinements of the method according to the invention are specified in the dependent claims 2 to 10.

A tool necessary for this and according to the invention for producing such a contact maker is specified in claim 11.

A contact maker according to the invention are specified in claim 12.

Further advantageous refinements of the contact maker for this are specified in the other claims.

The aim of the considerations is to provide the slots and apply an outer contact contour directly in the powder metallurgical production process of the contact material. This measure allows the costs for generating the contact maker geometry to be partly or entirely avoided. A further cost saving is achieved by reducing the required use of powder material, doing away with the material volume of the slots, and possibly also the usually necessary oversize.

The cited prior art describes a multilayer contact that has the features of the MLC contact maker but is not produced by a molten process, but instead the two layers are bonded to each other by soldering.

The essence of the method according to the invention is therefore that the contact makers are produced with near final contours and near final dimensions in a powder-metallurgical process in which said slots are already provided in the green compact and are fixed during the subsequent sintering.

The slots may in this case extend openly outward to the edge, or else be configured as slots beginning and ending within the contact surface.

In a further refinement, the powder material comprises a mixture of chromium powder and copper powder for the entire cross section of the contact maker.
In order here to implement similarly the technology of a multilayer contact, it is provided here that, for the production of a multilayered contact maker, a first green compact, consisting of pure copper powder, is separately produced and after that a green compact comprising a mixture of chromium powder and copper powder is produced by pressing, and the two green compacts are then sintered separately or together with one on top of the other. In this refinement, the different green compacts are produced one after the other.
In a further and alternative advantageous refinement, it is specified that, for the production of a multilayered contact maker, first a first layer, consisting of pure copper powder, and then a layer comprising a mixture of chromium powder and copper powder are introduced into a common pressing mold, and they are subsequently pressed together to form a layered green compact, which is subsequently sintered.

In order nevertheless to compensate for possible deviations that may occur during sintering, the contact maker can then finally be brought into the desired dimensions once again in a pressing operation for calibration.

Advantageously, to improve the properties, further additives, such as tungsten and/or tungsten carbide, and/or molybdenum, and/or platinum, and/or zirconium, and/or yttrium, and or palladium and/or silver, may be used in the powder mixture or as an alloyed powder mixture.

The grain size of the powder particles is preferable chosen between >0 and 150 micrometers.

A sintering of the contact makers should preferably be performed under a high vacuum atmosphere.

In a further advantageous refinement, the sintering of the components may be carried out under a hydrogen atmosphere (reducing atmosphere), possibly with a subsequent heat treatment of the components under a high vacuum atmosphere.

In this case, it may be of advantage if the heat treatment is performed synchronously in time with the production steps of a vacuum switching chamber. This saves quite considerable time and makes production less complex, since the finished vacuum switching chamber comprises said contact makers. The metallic material is thermally annealed (in particular the contact material) and the vacuum atmosphere is at the same time brought to an end.

With respect to a tool for producing contact makers by the method as claimed in one of the claims, the invention comprises creating slots in the green compact by contours that are provided as positive mold profiles (topographies) in the pressing mold or in the punches comprising the pressing molds.

With respect to a contact maker, the invention comprises producing the contact makers with near final contours and near final dimensions in a powder-metallurgical process in which said slots are already provided in the green compact and are fixed during the subsequent sintering.

A further refinement is that a mixture of chromium powder and copper powder is used as the powder material.

In a further advantageous refinement, the contact maker is a multilayered contact maker.

Further additives may be used here, such as tungsten and/or tungsten carbide, and/or molybdenum, and/or platinum, and/or zirconium, and/or yttrium, and or palladium and/or silver, in the powder mixture or as an alloyed powder mixture.

The invention is described in more detail below and represented in the drawing, in which:

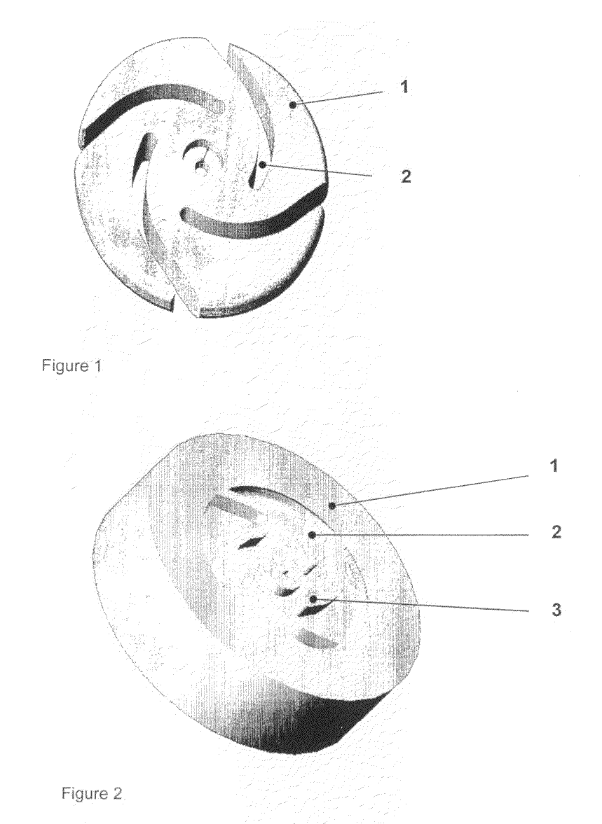

FIG. 1 shows a contact maker

FIG. 2 shows pressing molds with incorporated positive molding profiles (topographies) for forming the slots in the green compacts.

The production of a ready-to-install contact maker can be achieved by choosing a powder-metallurgical production process in the following way:

FIG. 1 shows the finished contact maker (1) after production, with slots (2) provided in it. FIG. 2 shows the pressing tool (1), which has depressions (2) and the slots lands (3). The slots lands (3) may be movably mounted in the pressing tool (1). If the pressing tool (1) is made with smaller dimensions to allow for shrinkage (after the sintering of the green compact), it can be used as a calibrating pressing tool.

### Powder Production and Pressing:

After mixing the copper and chromium powders, the powder mixture is introduced into a pressing mold, which comprises not only the required upper and lower punches but also webs, for example on one side of the punches. It could also be necessary for the webs likewise to be movably arranged, for example in the punch. The two webs are for their part to be refined in such a way that the outer geometry is to be applied at the same time and together with the slots during the pressing of the powder mixture on the green compact created.

After demolding the green compact, a blank is obtained with dimensions near those of the drawing, but provided with the required sintering allowance (shrinkage allowance) before the sintering of the material. The design of the tool and the number of trials can be reduced by the use of corresponding calculation software for the sintering, which predicts in advance much of any possible warpage that may occur, for example during the subsequent sintering (for example differences in density that remain in the green compact during pressing, sintering activity . . . ).

### Sintering:

The sintering of the green contact makers can be performed in the accustomed way under a vacuum atmosphere and/or a hydrogen atmosphere. However, in the production of a ready-to-install contact maker, a reducing atmosphere may/should be present at least at intermittent times (heat treatment annealing). After this reducing process step, a heat treatment under a “pure” vacuum atmosphere may possibly be advantageous for reducing the H₂ gas content in the material.

### Calibration Pressing:

In the event that inadmissible warpage of the ready-to-install contact maker nevertheless occurs during the sintering process, or the predetermined final dimensions are not achieved, the contact maker can be calibrated, and thereby brought to its final dimensions, in a further pressing process.

1. A method for producing contact makers for vacuum switching chambers of low-voltage, medium-voltage and high-voltage switching chambers, in which the contact makers are provided with slots extending from the middle area of the contact to the edge, and also a contact maker itself, wherein the contact makers are produced with near final contours and near final dimensions in a powder-metallurgical process in which said slots are already provided in the green compact and are fixed during the subsequent sintering.

2. The method as claimed in claim 1, wherein a mixture of chromium powder and copper powder is used as the powder material.

3. The method as claimed in claim 1, wherein a mixture of tungsten powder and copper powder is used as the powder material.

4. The method as claimed in claim 1, wherein a powder mixture of tungsten carbide powder and copper powder is used as the powder material.

5. The method as claimed in claim 1, wherein for the production of a multilayered contact maker, first a first green compact, consisting of pure copper powder, and then a green compact comprising a mixture of chromium powder and copper powder are produced by pressing, and the two green compacts are then sintered separately or together with one on top of the other.

6. The method as claimed in claim 1, wherein for the production of a multilayered contact maker, first a first layer, consisting of pure copper powder, and then a layer comprising a mixture of chromium powder and copper powder are introduced into a common pressing mold, and they are subsequently pressed separately or together to form a layered green compact, which is subsequently sintered.

7. The method as claimed in claim 1, wherein in the case of possible deviations that may occur during sintering, the contact maker is then brought into the desired dimensions once again in a pressing operation for calibration.

8. The method as claimed in claim 1, wherein further additives, such as tungsten and/or tungsten carbide, and/or molybdenum and/or platinum, and/or zirconium, and/or yttrium, and/or palladium and/or silver, are used in the powder mixture or as an alloyed powder mixture.

9. The method as claimed in claim 1, wherein the grain size of the powder particles lies between >0 and 150 micrometers.

10. The method as claimed in claim 1, wherein the contact maker is sintered under a hydrogen atmosphere and at the same time reduced.

11. The method as claimed in claim 1, wherein the contact maker is sintered under a high vacuum atmosphere and at the same time degassed.

12. The method as claimed in claim 9, wherein a heat treatment is performed synchronously in time with the production steps of a vacuum switching chamber.

13. A tool for producing contact makers by the method as claimed in claim 1, wherein slots are created in the green compact by contours that are provided as (positive mold profiles) topographies in the pressing mold or in the punches comprising the pressing molds.

14. A contact maker for vacuum switching chambers of low-voltage, medium-voltage and high-voltage technology, with slots extending from the middle area of the contact to the edge, wherein the contact makers are produced with near final contours and near final dimensions in a powder-metallurgical process in which said slots are already provided in the green compact and are fixed during the subsequent sintering.

15. The contact maker as claimed in claim 14, wherein a mixture of chromium powder and copper powder is used as the powder material.

16. The contact maker as claimed in claim 14, wherein the contact maker is a multilayered contact maker.

17. The contact maker as claimed in claim 14, wherein further additives, such as tungsten and/or tungsten carbide, and/or molybdenum, and/or platinum, and also platinum, and/or yttrium, and/or palladium and/or silver, are used in the powder mixture or as an alloyed powder mixture.

18. The contact maker as claimed in claim 15, wherein the contact maker is a multilayered contact maker.

19. The contact maker as claimed in claim 15, wherein further additives, such as tungsten and/or tungsten carbide, and/or molybdenum, and/or platinum, and also platinum, and/or yttrium, and/or palladium and/or silver, are used in the powder mixture or as an alloyed powder mixture.

20. The contact maker as claimed in claim 16, wherein further additives, such as tungsten and/or tungsten carbide, and/or molybdenum, and/or platinum, and also platinum, and/or yttrium, and/or palladium and/or silver, are used in the powder mixture or as an alloyed powder mixture.
